(19) United States
(12) Patent Application Publication
(10) Pub. No.: US 2008/0284183 A1
(43) Pub. Date: Nov. 20, 2008

(54) IMPACT BEAM WITH DOUBLE-WALL FACE

(75) Inventor: Thomas J. Johnson, Fruitport, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/873,839

(22) Filed: Oct. 17, 2007

Related U.S. Application Data
(60) Provisional application No. 60/938,058, filed on May 15, 2007.

(51) Int. Cl. B60R 19/02; B21B 1/08; B21D 53/88; B23K 37/00; B23P 17/00

(52) U.S. Cl. 293/102; 228/17.5; 29/897.2; 72/199

(57) ABSTRACT

A bumper reinforcement beam includes a first sheet forming at least one tube including a front wall, and a second sheet welded to and supporting the front wall in a laminar arrangement adding stiffness to the front wall. A related method includes uncoiling and welding the first and second sheets together, and forming the first sheet into a tubular shape with a first portion forming a front wall, the second sheet supporting the first portion. An apparatus includes a pair of uncoilers for uncoiling first and second sheets of material together, a welder securing the first and second sheets together, and a roll forming mill configured to roll form the sheets into a tubular shape, where the first sheet defines a front wall and portions of the second sheet supporting the front wall.

### CROSS REFERENCE TO RELATED APPLICATION

This claims benefit of a provisional application under 35 U.S.C. §119(e), Ser. No. 60/938,058, filed May 15, 2007, entitled IMPACT BEAM WITH DOUBLE WALL FACE.

### BACKGROUND

The present invention relates to reinforcement beams such as can be used for vehicle bumpers.

Vehicles bumper beams have conflicting functional requirements. For example, vehicle bumper beams require high beam strength for impact resistance (which can be achieved by using thicker materials), but also require low weight for good gas mileage (which makes thinner materials desirable). More specifically, bumper beams require “good” material thickness and “adequate” stress-distributing properties especially near the point of impact, but material having “good” material thickness and “adequate” stress-distributing properties in one area results in excessive material in other locations where the thickness is not required. Also, a material having “adequate” or preferred stress distributing properties is often more expensive, resulting in higher-cost material being “wasted” in areas where it does not need to be such high-cost material. Notably, the industry that supplies bumper beams is extremely competitive and the volumes are typically high, such that it is desirable to manufacture the bumper beams by high volume processes such as roll-forming mills. However, roll-forming typically is done on sheet material having a constant thickness across its entire transverse section, which results in excess material in some areas where the increased thickness is not required. Secondary processes can be used to “pre-treat” or “post-treat” (or “concurrently-treat”) the roll-formed sheet, however these add considerably to manufacturing cost. Further, any secondary treatment can add to inconsistencies in the manufacturing process. It is noted that the dimensional and functional requirements for reinforcement beams in automotive bumpers are very demanding, which further complicates the above-noted problems.

In addition to the above, it is noted that the Insurance Institute of Highway Safety is developing a test that will drive the need for very stiff bumper beams. The test being developed is referred to as a “Frontal 40 mph Offset 10″ Pole Test”. To ensure proper function of the energy absorbing front structure of the vehicle, the bumper beams must be much stiffer than those found on vehicles today.

### SUMMARY OF THE PRESENT INVENTION

In one aspect of the present invention, a bumper reinforcement beam includes a tubular beam formed by first and second sheets of material, the first sheet forming at least one tube including a front wall, a top wall, a bottom wall, and a rear wall. The second sheet lays against at least the front wall in a laminar arrangement with the second sheet supporting the first sheet in a manner adding stiffness to the front wall. The beam also includes mounting brackets secured to ends of the beam and configured and adapted for attachment to vehicle frame rail tips.

In another aspect of the present invention, a method comprises steps of uncoiling first and second sheets of material into a laminar relationship, the first sheet having outer portions extending wider than the second sheet and securing the first and second sheets together. The method further includes forming the first sheet into a tubular shape including at least one tube section, with the first sheet having a first portion forming a front wall and the second sheet having a second portion laying against and supporting the first portion in a laminar relationship. Still further, the method includes welding the first sheet to form a permanent tubular shape, cutting the permanent tubular shape into beam segments, and attaching mounting brackets to ends of each of the beam segments, the mounting brackets being configured and adapted for attachment to frame rail tips of a vehicle frame.

In still another aspect of the present invention, an apparatus comprises a pair of uncoilers for uncoiling first and second sheets of material in a laminar relationship, a welder for securing the first and second sheets together along at least two weld lines, and a roll-forming mill configured to roll form the first and second sheets into a tubular shape with at least one tube section, with first portions of the first sheet defining a front wall and second portions of the second sheet laying against and supporting the first portion.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a B-shaped reinforcement beam configured for use in a vehicle bumper system.

FIGS. 2-3 are cross-sectional views taken along the line II-II in FIG. 1, the FIGS. 2-3 showing alternative embodiments of the beam.

FIGS. 4-5 are cross-sectional views of alternative D-shaped reinforcement beams.

### DETAILED DESCRIPTION OF PREFERRED EMBODIMENTS

In the present disclosure, the terms upper, lower, front, rear, top, bottom and other similar words of relative position are used to facilitate the discussion. However, these terms are not intended to be unnecessarily limiting. Further, the terms are used below to describe the beams in a vehicle-mounted orientation, and are not used to describe the beams as oriented in a roll forming mill.

The present concept of increased front face stiffness bumper beam focuses on putting the thicker material where it is needed and not carrying the added weight around the entire cross section. This is accomplished by adding a narrow width coil of steel (Material 2) to the top of the wider cross section strip (Material 1). Material 1 and Material 2 could be of different thickness and/or different material type. These two materials would be welded together before the roll-forming process begins, such as between the coil stands and the rolling mill. The welding could be accomplished by rotary seam welding, rotary spot welding, or another type of known welding. Notably, the welding attaches the two sheets together, but the welding is located at a location where the welding will not be a quality problem and where it will not undesirably affect predictability of impact absorption upon a vehicle crash.

The beams described below can be made to meet a new test being developed by the Insurance Institute of Highway Safety, the test being known as a “Frontal 40 mph Offset 10″ Pole Test”. The present beam configuration ensures proper function of the energy absorbing front structure of the vehicle by being much stiffer than those found on vehicles today. At the same time, the present beams allow use of commercially available constant-thickness sheet material, yet avoid the problem of excessively thick material and waste in areas and where the thickness is not required.

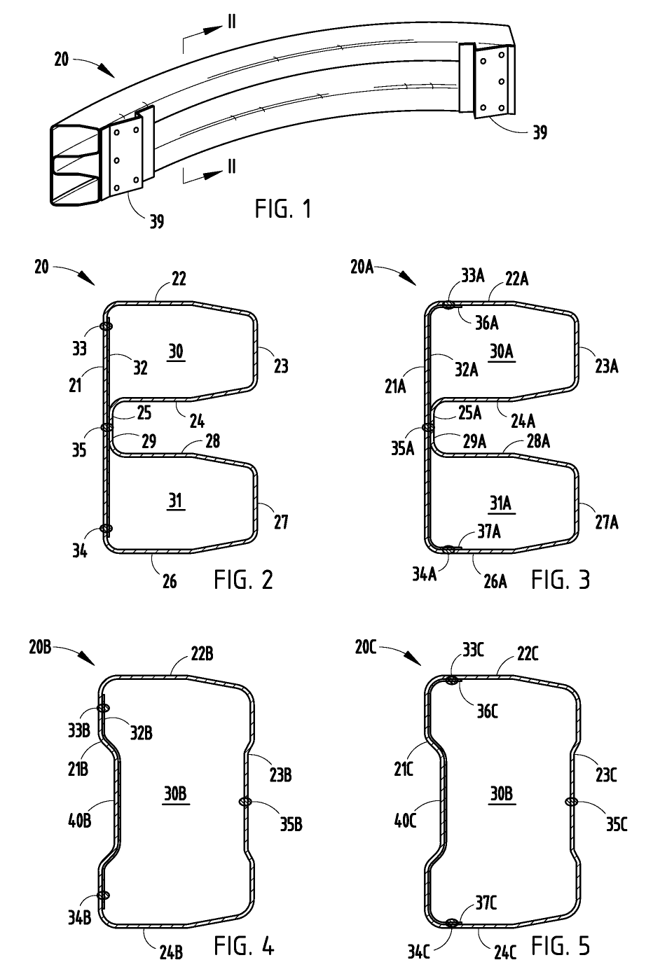

Specifically, beam 20 (FIGS. 1-2) is B-shaped, and includes a first sheet of material (material 1) forming a front wall 21, top wall 22, upper rear wall 23, upper mid wall 24, upper attachment flange 25, bottom wall 26, lower rear wall 27, lower mid wall 28, and lower attachment flange 29. The walls 21-24 form a top tube 30, and the walls 21, 26-28 form a bottom tube 31, with the walls 24, 28 and flanges 25, 29 forming a channel therebetween. A second sheet of material (material 2) includes a section 32 that extends substantially a full height of the front wall 21. Top and bottom welds 33 and 34 attach the first and second sheets together to prevent shifting and wandering during the roll-forming process. A middle weld 35 also secures the first and second sheets together at a center web location (i.e., where material connects the top and bottom tubes together). Specifically, the weld 35 secures the flanges 25 and 29 to the section 32 and to the front wall 21. Notably, the materials 1 and 2 can be selected for optimal results, including selection of optimal material properties as well as thickness. In one form, the first sheet (material 1) is a lower grade material, such as 80 ksi tensile strength steel or as low as 40 ksi tensile strength steel (or a structural steel or even lower grade steel); and the second sheet (material 2) is a higher grade material, such as a steel of greater than 80 KSI tensile strength, or more preferably of greater than 120 KSI tensile strength, or in some circumstances even 220 KSI tensile strength.

The illustrated beam 20 is swept to a longitudinally curved non-linear shape by a sweep station located down-stream of the roll former mill and prior to when the tubular shape is cut into beam segments. Brackets 39 are welded to each end of the beam 20 for providing attachment to a vehicle frame. The illustrated brackets 39 include apertured flat panels that are co-planar and configured for attachment to a vehicle's frame rail tip.

Beam 20A (FIG. 3) is similar to beam 20, and identical and similar features and characteristics are identified by the same numbers, but with the addition of the letter “A”. This is done to reduce redundant discussion. Beam 20A includes similar features 21A-35A. However, in beam 20A, the height of the second sheet 2 is extended to include top and bottom sections 36A and 37A, respectively. The section 36A extends around the corner formed by the front wall 21A and top wall 22A, and extends onto the top wall 22A. Weld 33A is moved to the top wall 22A. Similarly, the section 37A extends around the bottom corner formed by the front wall 21A and the bottom wall 26A, and weld 34A is moved to the bottom wall 26A. This arrangement adds considerably to a bending strength of the beam 20A, both due to the additional support of the second sheet on the first sheet, but also based on the channel shape of the second sheet.

It is contemplated that the present invention can be used on other beam shapes. Beam 20B and 20C (FIGS. 4-5) are not totally unlike beam 20, and identical and similar features and characteristics are identified by the same numbers, but with the addition of the letters “B” and “C”. This is done to reduce redundant discussion.

Specifically, FIGS. 4-5 show single-tube beams (often called D-shaped beams). Beam 20B (FIG. 4) includes a first sheet of material (material 1) forming a front wall 21B, top wall 22B, rear wall 23B, and lower rear wall 24B. The walls 21B-24B form a tube 30B. A second sheet of material (material 2) includes a section 32B that extends substantially a full height of the front wall 21B. Top and bottom welds 33B and 34B attach the first and second sheets together to prevent shifting and wandering during the roll-forming process. Additional welds can be used if desired. A third weld 35B also secures the ends of the first sheet together. Notably, the materials 1 and 2 can be selected for optimal results, including selection of optimal material properties as well as thickness. As illustrated, the front wall 21B includes a shallow depression or rib 40B, which is formed in both the first and second sheets. It is noted that this rib 40B adds considerable strength to the arrangement, especially since it is formed by both the first and second sheets.

Beam 20C (FIG. 5) is similar to beam 20B and includes walls 21C-24C and welds 33C-35C. However, in beam 20C, the height of material 2 is extended so that it includes top and bottom sections 36C and 37C, respectively. The top section 36C extends onto the top wall 22C and is anchored by weld 33C. The bottom section 37C extends onto the bottom wall 24C and is anchored by weld 34C. As illustrated, the front wall 21C includes a shallow depression or rib 40C which is also formed in the second sheet.

The present process can be varied as required for particular manufacturing needs. However, in a preferred form, the sheets 1 and 2 are uncoiled and welded together prior to entry into the roll-forming mill. (See FIG. 5 of Sturrus U.S. Pat. No. 5,395,036 which shows an exemplary roll-forming process, the entire contents of which are incorporated herein for their teachings.) The sheets 1 and 2 are then processed as a unit through the roll-forming mill, including forming the sheets 1 and 2 into a B shape (or D shape), welding the material to form a permanent B beam (or D beam), sweeping the beam to a curved shape as desired, and cutting into beam segments of desired length. Notably, it is contemplated that the welding can be of any type known, such as rotary seam welding, spot welding, induction welding, and the like.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. A bumper reinforcement beam comprising:
a tubular beam including first and second sheets of material, the first sheet forming at least one tube including a front wall, a top wall, a bottom wall, and a rear wall; the second sheet laying against at least the front wall in a laminar arrangement; the second sheet supporting the first sheet in a manner adding stiffness to the front wall; and
mounting brackets secured to ends of the beam and configured and adapted for attachment to vehicle frame rail tips.

2. The beam defined in claim 1, wherein the first sheet forms at least two tubes connected by a web portion, and the second sheet extends across the web portion and further across at least a portion of each of the two tubes.

3. The beam defined in claim 1, wherein the second sheet includes top and bottom portions extending onto the top and bottom walls, respectively, of the first sheet.

4. The beam defined in claim 1, wherein the second sheet is secured to the first sheet in at least a top location and a bottom location.

5. The beam defined in claim 4, wherein the second sheet is also secured to the first sheet in at least a centered third location between the top and bottom locations.

6. The beam defined in claim 1, wherein the front wall has a channel formed therein.

7. The beam defined in claim 1, wherein the second sheet has a tensile strength of greater than about 80 KSI.

8. The beam defined in claim 7, wherein the second sheet has a tensile strength of greater than about 120 KSI.

9. The beam defined in claim 7, wherein the first sheet has a tensile strength of less than about 80 KSI.

10. The beam defined in claim 1, wherein the mounting brackets are attached to the rear wall.

11. The beam defined in claim 1, wherein the beam has a non-linear shape.

12. The beam defined in claim 1, wherein the tubular beam has a B-shaped vertical section, with the front wall being generally flat from top to bottom.

13. The beam defined in claim 12, wherein the first and second sheets are welded together in at least three locations vertically spaced from each other.

14. A method comprising steps of:
uncoiling first and second sheets of material into a laminar relationship, the first sheet having outer portions extending wider than the second sheet;
securing the first and second sheets together;
forming the first sheet into a tubular shape including at least one tube section, with the first sheet having a first portion forming a front wall and the second sheet having a second portion laying against and supporting the first portion in a laminar relationship;
welding the first sheet to form a permanent tubular shape;
cutting the permanent tubular shape into beam segments; and
attaching mounting brackets to ends of each of the beam segments, the mounting brackets being configured and adapted for attachment to frame rail tips of a vehicle frame.

15. The method defined in claim 14, wherein the steps occur in the sequence listed in claim 14.

16. The method defined in claim 14, including a step of sweeping the permanent tubular shape into non-linear shape.

17. An apparatus comprising:
a pair of uncoilers for uncoiling first and second sheets of material in a laminar relationship;
a welder for securing the first and second sheets together along at least two weld lines;
a roll-forming mill configured to roll form the first and second sheets into a tubular shape with at least one tube section, with first portions of the first sheet defining a front wall and second portions of the second sheet laying against and supporting the first portion.

18. The apparatus defined in claim 17, wherein the roll-forming mill includes rollers configured to form a longitudinal channel in the first and second portions that extends along the front wall for stiffening the front wall.

19. The apparatus defined in claim 17, wherein the roll-forming mill includes rollers configured to roll the first and second sheets into two tubular shapes interconnected by a transverse web portion, the welder being configured to weld through the web portion as well as along top and bottom edges of the second sheet.

20. The apparatus defined in claim 17, including a sweep station for sweeping the tubular shape into a non-linear shape.

21. The apparatus defined in claim 17, including a second welder for welding the tubular shape into a permanent tubular shape.
